(19) United States
(12) Patent Application Publication
(10) Pub. No.: US 2026/0320904 A1
(43) Pub. Date: Oct. 15, 2026

(54) Method, System and Device for Generating a Bird's-Eye View Representation from Image Data Captured by a Camera

(71) Applicant: Robert Bosch GmbH, Stuttgart (DE)

(72) Inventors: Eashwara Sudharsan Erahan, Hildesheim (DE); Fabian Gigengack, Hemmingen (DE); Simon Roesler, Hildesheim (DE)

(21) Appl. No.: 19/641,002

(22) Filed: Apr. 7, 2026

(30) Foreign Application Priority Data
Apr. 10, 2025 (DE) 10 2025 114 179.7

(51) Int. Cl. G06T 15/20; G06T 15/04; G06T 15/50

(52) U.S. Cl. CPC G06T 15/20; G06T 15/04; G06T 15/506

(57) ABSTRACT

A method for generating a bird's-eye view (BEV) representation from 3D-image data captured by a camera includes (i) generating unscaled ray features for each image column of the image data, in particular by transforming from a projective image space to a BEV space, wherein the ray features represent appearance information of each image column, (ii) obtaining a focal length of the camera, and (iii) resampling the ray features onto a BEV grid based on the focal length of the camera, thereby generating the BEV representation.

This application claims priority under 35 U.S.C. § 119 to patent application no. DE 10 2025 114 179.7, filed on Apr. 10, 2025 in Germany, the disclosure of which is incorporated herein by reference in its entirety.

The present disclosure relates to a method, device, and system for generating a bird's-eye view (BEV) representation from image data, particularly in the context of 3D perception for autonomous driving. The disclosure addresses the limitations of current state-of-the-art methods that struggle to generalize across different camera focal lengths.

### BACKGROUND

Camera-based 3D perception is gaining significant importance in autonomous driving software stacks. Usually, the camera features undergo transformation from the camera frustum space to a Cartesian Bird's-Eye View (BEV) space when they are used for 3D perception. These camera-based 3D perception systems are reaching state-of-the art performance for a given camera setup, however fail to generalize over different camera focal lengths owing to the way they are designed in current deep learning based architectures. This means when a different camera is used as an input to a well-trained camera-based perception system trained with initial camera, the generalisation to a new camera input is often very poor as this was never part of the training data.

A known approaches trying to solve this issue currently is AeDet (Azimuth-invariant Multi-view 3D Object Detection) as described in C. Feng, Z. Jie, Y. Zhong, X. Chu, and L. Ma, “Aedet: Azimuth-invariant multi-view 3d object detection,” 2023. [Online]. Available: https://arxiv.org/abs/2211.12501

This approach introduces a camera decoupled virtual depth module which predicts depth decoupled to the camera focal length and then re-samples the depth based on the cameras'focal length. Estimating depth this way allows for a better depth estimation generalization to new camera focal lengths. However, AeDet does not guarantee a camera decoupled BEV transformation.

### SUMMARY

This disclosure provides a method to make a generalisation across different camera focal lengths possible.

According to a first aspect, the disclosure provides a camera-agnostic Bird's Eye View (BEV) transformation method that decouples the generation of ray features from metric scaling. The ray features are in particular created by transforming from a projective image space to a BEV space, wherein the ray features represent appearance information of each image column. The method comprises generating unscaled ray features for each image column of the input image data. An image column represents a vertical sequence of pixels in the 2D image. Each image column corresponds to a projected ray originating from the camera's optical centre.

In particular, for every pixel feature in the projective space an unscaled depth value is predicted. A 3D volume can be built by performing an outer product of the pixel feature and the unscaled depth and then summing along the vertical axis to form the ray features (BEV space). The pixel features and ray features map to each other in a column wise manner.

Unlike conventional methods, these ray features represent appearance information, such as colour, texture, and encoded visual features, without being scaled based on the camera's focal length.

This transformation from projective image space to BEV space involves predicting ray features for every image column in a manner that anticipates their eventual placement on the BEV grid but defers the actual metric scaling until the focal length of the camera is incorporated. This initial representation allows for a more generalized feature extraction process that is independent of the specific camera parameters.

The method then obtains the focal length of the camera. This can be achieved in various ways, including extracting focal length information from metadata embedded within the image data, retrieving it from camera calibration parameters, or obtaining it from active zoom control settings. The focal length information is crucial for the subsequent resampling step. Obtaining the focal length from image metadata offers a practical and efficient implementation, as it leverages readily available information associated with the image data itself. This eliminates the need for separate calibration procedures or external communication with the camera system.

Finally, the method resamples the unscaled ray features onto a BEV grid based on the obtained focal length. This resampling process maps each ray feature to its correct metric location in the BEV space, ensuring accurate spatial representation regardless of the camera's zoom level. The ray features can be described as a distribution or a single relative estimate, providing flexibility in implementation. Representing ray features as a distribution allows for a more nuanced representation of the visual information along each ray, potentially capturing uncertainties or variations. Conversely, a single relative estimate offers a simpler and more computationally efficient representation, which may be sufficient for certain applications.

This camera-agnostic approach allows the system to generalize to different camera focal lengths without retraining, improving performance and robustness compared to state-of-the-art methods. The disclosure is applicable to various 3D perception tasks in autonomous driving, including object detection, lane line detection, and occupancy mapping, even in self-supervised settings. This broad applicability stems from the disclosure's ability to provide a robust and accurate BEV representation, which is a fundamental building block for many perception tasks.

The disclosure is also embodied in a device comprising a processing unit, means for obtaining focal length of the camera used to capture the to-be-processed images, and a resampling unit. In a preferred embodiment, the processing unit is configured as a network for 3D perception, comprising a feature encoder, a ray predictor and a ray to BEV sampler. The feature encoder creates a compact representation of the input image, which is then processed by the ray predictor to generate the unscaled ray features. The ray to BEV sampler performs the focal length-based resampling onto the BEV grid, a ray to BEV sampler configured to resample the ray features onto a BEV grid based on the focal length of the camera, thereby generating the BEV representation. This modular architecture facilitates efficient processing and integration into existing perception pipelines.

The device may in particular be designed in a way that the BEV representation is passed through a BEV decoder and is then provided as input to at least one task specific head, where the head is in particular designed as a 3D-object detection head or a 3D occupancy head, and where the head provides output data that is used for the specified task.

The ray predictor component may for example be implemented as a Multi-Layer Perceptron (MLP) or as a Transformer.

Furthermore, the disclosure is implemented as a system comprising at least one camera and a processing unit. The system captures image data, generates unscaled ray features, determines focal length, and resamples the features to create the BEV representation. This system-level implementation highlights the practical application of the disclosure in a real-world autonomous driving context.

In a preferred embodiment the system comprises multiple cameras that may have differing focal lengths. Preferably, at least two of the cameras have different focal lengths, and the BEV representation is generated by resampling of ray features from at least two sets of image data captured by those different cameras, based on the respective focal length of each camera. In particular, the BEV representation may be generated by resampling of ray features from at least two sets of image data captured by those different cameras, based on the respective focal length and relative position of each camera. The ray features from different cameras can have overlapping rays and non-overlapping rays. The non-overlapping areas can be easily resampled to the BEV grid but the overlapping rays from different cameras require an additional step like average or sum or max after resampling.

By decoupling ray feature generation from metric scaling and incorporating the camera's focal length explicitly during resampling, the present disclosure achieves a camera-agnostic BEV transformation, enabling improved generalization, accuracy, and robustness in 3D perception for autonomous driving.

### BRIEF DESCRIPTION OF THE DRAWINGS

Embodiments of the approach presented here are illustrated in the drawings and explained in greater detail in the subsequent description.

FIG. 1 illustrates the generation of ray features according to an embodiment of the disclosure.

FIG. 2 shows a schematic diagram of a camera-based 3D perception system according to an embodiment of the disclosure.

FIG. 3 illustrates schematically a method for BEV generation as known from the prior art.

FIG. 4 illustrates schematically a method for BEV generation according to an embodiment of the disclosure.

### DETAILED DESCRIPTION

In the subsequent description of advantageous embodiments of the present disclosure, similarly, acting elements illustrated in the various figures are designated by the same or similar reference numerals, wherein repeated description of these elements shall be omitted.

Wherever an embodiment includes an “and/or” link between a first feature and a second feature, this is to mean that the embodiment comprises both the first feature and the second feature in a first variant and either the first feature or the second feature in a further variant.

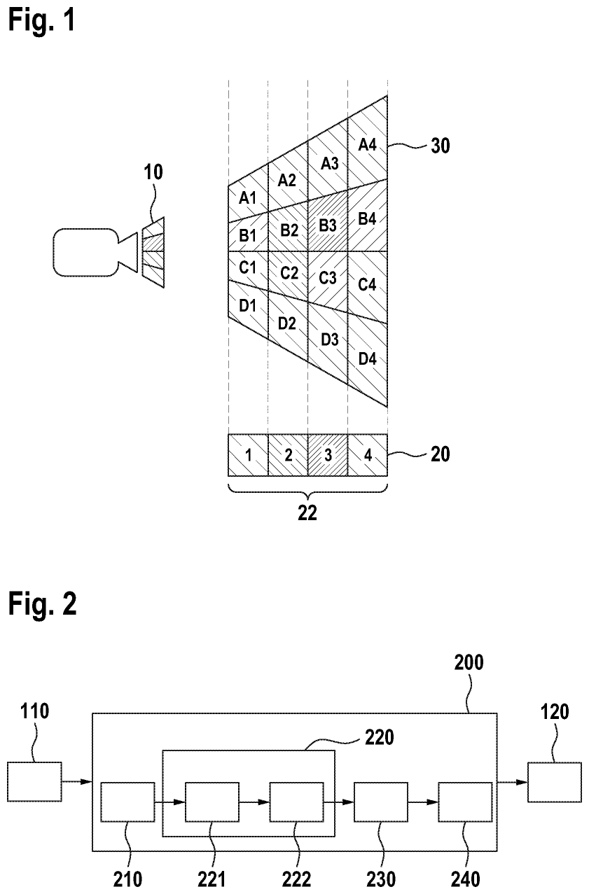

FIG. 1 shows the principle of how to build a 3D volume 100 from each image column 10 by performing an outer product of the pixel feature and unscaled depth and then sum along the vertical axis to form the ray features 20 in the BEV space 22. The pixel features (A, B, C, D) and ray features (1, 2, 3, 4) map to each other in a column wise manner. In that way, it is possible to predict an unscaled depth value for every pixel feature of the projective space.

FIG. 2 shows an example for a camera-based 3D perception system according to an embodiment of the disclosure. The system comprises a network for 3D perception 200. The camera input image 110 is provided to the network for 3D perception 200. The input image undergoes feature encoding 210. The output of the feature encoder 210 can potentially be at a down-sampled resolution of the input image. The generic BEV transformation according to the disclosure has two components to it. The first component, the so-called ray predictor 221, predicts a ray feature of uniform length for every encoded image feature column (see FIG. 1). The ray feature can be interpreted as a redistribution of image column features along its corresponding BEV ray. The predicted ray is then resampled on a Cartesian BEV grid by the ray to BEV sampler 222 based on the known focal length of the camera that captured the image data 110.

The sampled features are then passed through a BEV decoder 230 and then provided as input for task specific heads 240 like, e.g. an 3D object detection head or a 3D occupancy head which then provide the required outputs 120.

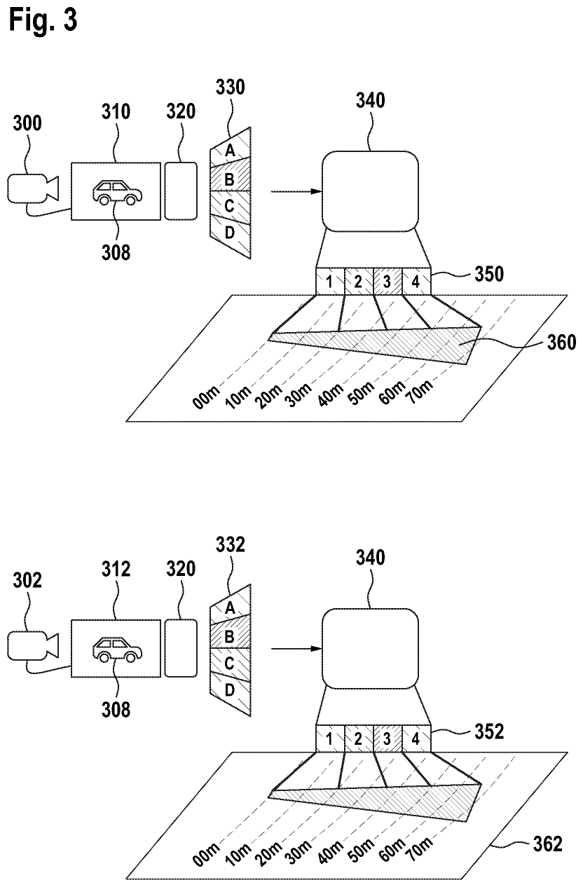

FIG. 3 illustrates schematically a method for BEV generation as known from the prior art. It is assumed in the shown example, that two cameras 300 and 302 with different focal lengths (e.g., camera 300 has a focal length of 400 mm, camera 302 has a focal length of 800 mm) look at the same object (car) 308 in the real world from the exact same distance. Since the focal length of camera 302 is twice that of camera 300, the image 312 generated by camera 302 will have twice the zoom factor of the image 310 created by camera 300. Hence the car 308 in the image 312 generated by camera 302 will be roughly twice the size of car 308 in the image 310 generated by camera 300. It is to be noted that the car 308 is at the same distance from both cameras 300, 302 but appears differently because of the different focal lengths.

The images 310, 312 from camera 300 and camera 302 undergo feature encoding 320 as the first step. The main purpose of a BEV transformation is to map features in the perspective space to features in BEV space. The ray predictor component 340 of the BEV transform predicts ray features 350, 352 for every column 330, 332 in the respective image 310, 312. In the usual, known BEV transformation case, these ray features 350, 352 are already metrically re-sampled, irrespective of the actual camera focal length.

The network is thus forced to implicitly learn how to scale the features that are sampled into metric BEV space 360, 362.

Implicitly learning to metrically scale features has two main disadvantages. First, the learned scaling factor is specific to the camera focal length the network was trained on, which leads to poor generalisation performance of the network. Second, this implicit learning to scale features comes at extra computation effort to the network, so a comparably larger network capacity is required to solve this task.

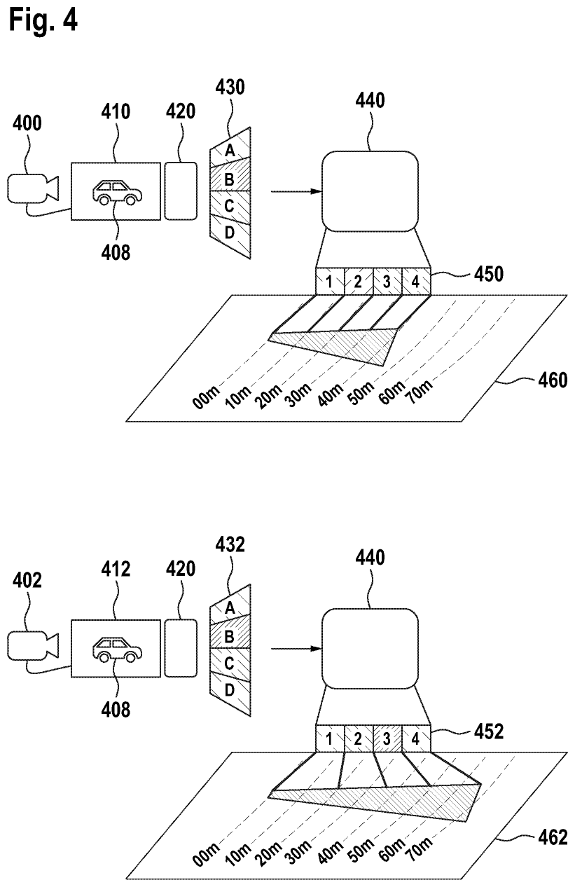

FIG. 4 illustrates schematically a method for BEV generation according to the disclosure, which allows generic BEV transformation. The ray-features predicted inside the BEV transformer are resampled based on the known focal length of the camera. Performing a focal length-based resampling of ray features on to the BEV feature space allows for the network to predict the ray features just based on appearance which is a much easier task than learning to implicitly scale the ray features.

In the shown example, a car 408 appears larger in the image 412 created by a second camera 402 compared to first image 410 created by a first camera 400. The prediction of respective ray features 450, 450 is only based on this appearance, meaning the ray features 450, 452 can be different between camera 400 and camera 402, because the car appears differently in the respective images 410 and 412 and no implicit scaling factor needs to be learned.

Since the focal length of camera 402 is higher, the ray-features 452 get sampled father away from the camera 402. This way it is ensured that the ray features of camera 402 (which sees the car 408 bigger although it is farther away) is placed at the correct distance from camera 402 while re-sampling the ray features 452 to the BEV space 462. The main advantage of explicitly scaling the ray features 450, 452 in a subsequent step allows for the network to become camera agnostic, boosting generalisation capabilities of the network. This means a network trained on camera 400, will perform well on camera 402, when using generic BEV transformation, compared to the usual, prior-art BEV transformation.

This disclosure addresses the challenges of 3D perception in autonomous driving, particularly the limitations of current methods in handling varying camera focal lengths and zoom levels. The disclosure provides a novel approach to generating bird's-eye view (BEV) representations from image data, enabling improved generalization, accuracy, and robustness across diverse camera configurations.

The core of the disclosure is a camera-agnostic BEV transformation method. This method introduces a crucial decoupling between the generation of ray features and metric scaling. The process begins by generating unscaled ray features for each image column of the input image data. An image column is a vertical sequence of pixels in the 2D image. Each column corresponds to a projected ray originating from the camera's optical centre. These ray features encapsulate appearance information, such as colour, texture, and learned visual characteristics, along each ray. Importantly, they are initially generated without incorporating the camera's focal length, unlike conventional methods that bake in scaling during feature extraction, thus limiting their adaptability to different cameras. This decoupling enables a more generalized feature representation. The transformation from projective image space to BEV space involves predicting these ray features for every image column, effectively setting the stage for their eventual placement on the BEV grid while preserving their camera-independent nature.

Next, the method obtains the camera's focal length. This can be done via various techniques, including extracting the information from image metadata, accessing pre-calibrated camera parameters, or using feedback from active zoom control. Obtaining the focal length directly from image metadata is a particularly efficient approach as it leverages readily available information.

The method then resamples the unscaled ray features onto a BEV grid using the obtained focal length. This resampling process maps each ray feature to its proper metric location in the BEV space, ensuring accurate spatial representation irrespective of the camera's zoom or field of view. The ray features can be represented either as a distribution to capture potential uncertainty or variation, or as a single relative estimate for a simpler and more computationally efficient implementation. This focal length-based resampling ensures that the initially unscaled features are correctly positioned on the BEV grid.

This camera-agnostic approach allows the system to adapt to different camera focal lengths without requiring retraining, leading to increased performance and robustness. The disclosure is widely applicable to various 3D perception tasks in autonomous driving, such as object detection, lane line detection, and occupancy mapping, and functions effectively even within self-supervised learning frameworks. This versatility stems from the disclosure's capacity to generate a consistent and accurate BEV representation, which forms the basis for many perception tasks.

What is claimed is:

1. A method for generating a bird's-eye view (BEV) representation from 3D-image data captured by a camera, the method comprising:
a) generating unscaled ray features for each image column of the image data by transforming from a projective image space to a BEV space, wherein the ray features represent appearance information of each image column;
b) obtaining a focal length of the camera; and
c) resampling the ray features onto a BEV grid based on the focal length of the camera, thereby generating the BEV representation.

2. The method according claim 1, wherein the focal length of the camera is obtained by extracting focal length information from meta-data comprised by the image data.

3. The method according to claim 1, wherein the ray features are described as a distribution or as a single relative estimate.

4. The method according to claim 1, wherein the method is used in 3D object detection and/or lane line detection and/or 2D or 3D occupancy, including self-supervised tasks.

5. A device for generating a bird's-eye view (BEV) representation from image data captured by a camera, the device comprising:
a) a processing unit configured to generate unscaled ray features for each image column of the image data by transforming from a projective image space to a BEV space, wherein the ray features represent appearance information of the image column;
b) means for obtaining a focal length of the camera; and
c) a resampling unit configured to resample the ray features onto a BEV grid based on the focal length of the camera, thereby generating the BEV representation.

6. The device according to claim 5, wherein the processing unit is configured as a network for 3D perception that comprises:
a feature encoder configured to create a downsampled version of the input image,
a ray predictor configured to predict a ray feature of uniform length for every encoded image feature column, wherein the ray feature is interpreted as a redistribution of image column features along its corresponding BEV ray, and
a ray to BEV sampler configured to resample the ray features onto a BEV grid based on the focal length of the camera, thereby generating the BEV representation.

7. The device according to claim 6, wherein the BEV representation is passed through a BEV decoder and then provided as input to at least one task specific head, wherein the head is designed as a 3D-object detection head or a 3D occupancy head, and wherein the head is configured to provide output data that is used for the specified task.

8. The device according to claim 6, wherein the ray predictor is implemented as a Multi-Layer Perceptron (MLP).

9. The device according to claim 6, wherein the ray predictor is implemented as a transformer.

10. A system for generating a bird's-eye view (BEV) representation, the system comprising:
a) at least one camera configured to capture image data; and
b) a processing unit configured to:
i. receive the image data from the camera;
ii. generate unscaled ray features for each image column of the received image data by transforming from a projective image space to a BEV space, wherein the ray features represent appearance information of the image column;
iii. determine the focal length of the camera; and
iv. resample the ray features onto a BEV grid based on the determined focal length of the camera, thereby generating the BEV representation.

11. The system according to claim 10, the system further comprising a device configured to generate the BEV representation.

12. The system according to claim 10, the system further comprising multiple cameras, wherein at least two of the cameras have different focal lengths, and the BEV representation is generated by resampling the ray features from at least two sets of image data captured by different cameras, based on the respective focal length of each camera.

13. A perception system for a vehicle, comprising the system according to claim 10.

14. The method according to claim 1, wherein the method is used in 3D perception of a vehicle's surroundings.
